(19) United States
(12) Patent Application Publication
(10) Pub. No.: US 2021/0380110 A1
(43) Pub. Date: Dec. 9, 2021

(54) Method for Reproducing an Error That Occurs During the Driving Operation of a Vehicle

(71) Applicant: Bayerische Motoren Werke Aktiengesellschaft, Muenchen (DE)

(72) Inventors: Sebastian GRASREINER, Graefelfing (DE); Florian HARTL, Muenchen (DE)

(21) Appl. No.: 17/296,274

(22) PCT Filed: Nov. 13, 2019
(86) PCT No.: PCT/EP2019/081093

§ 371 Date: May 24, 2021

(30) Foreign Application Priority Data
Dec. 4, 2018 (DE) 10 2018 130 759.4

(51) Int. Cl. B60W 30/18; B60W 50/06

(52) U.S. Cl. CPC B60W 30/18109; B60W 50/06; B60W 2510/0676; B60W 2050/065; B60W 2510/0638

(57) ABSTRACT

A method for reproducing an error that occurs during the driving operation of a vehicle is provided. The vehicle is fixed in position in order to prevent movement relative to a reference surface on which the vehicle is located. A speed profile provided by an engine analyzer is read into a control device of the vehicle and is converted by the control device into a load profile. Subsequently, with the brake activated, the control device in the vehicle automatically runs through the speed profile, the device having converted the speed profile into at least one control parameter of the engine and/or the transmission over time in order to simulate the load profile, when the vehicle is under load as a result of the activation of the brake.

### BACKGROUND AND SUMMARY OF THE INVENTION

The invention relates to a method for reproducing a fault that occurs during the driving operation of a vehicle, and to a computer program product and a control device of a vehicle which are configured to carry out the method.

During the operation of vehicles, their users frequently make complaints about the driving behavior of the vehicle or a fault while the vehicle is being driven. Vehicles are to be understood in respect of the present invention as both motor vehicles having an internal combustion engine as well as vehicles which can also be operated partially or completely electrically, such as hybrid-electric vehicles or battery-operated vehicles. In the case of the complaint about such a fault within the scope of a visit to a workshop, it is generally not possible to simulate the load situation under which the fault described by the customer occurs. In particular a roller test rig would be necessary for this. Such a rig is generally not present in workshops owing to the high investment costs. Furthermore, a use of a roller test rig entails considerable costs. For practical reasons it is also not possible to drive the vehicle about which there is complaints on the road until the fault can be reproduced.

This results in the problem for the servicing personnel, who should troubleshoot the fault, that it is not possible to reproduce a fault with the load situation which is described by a customer. At the same time, non-technical information about the vehicle user is generally not sufficient to diagnose the problem. Owing to the associated costs, uncertain repairs arising from an inaccurate diagnosis are frequently not carried out so that the customer can generally continue to perceive the problem and becomes dissatisfied. For the manufacturer of the vehicle, considerable costs can arise when there is a repair situation which is not successfully dealt with, and said costs could, however, be basically avoided if there were a better diagnostic possibility.

An object of the invention is to disclose a method which makes it possible to reproduce a fault occurring during the driving operation of a vehicle. It is also an object of the invention to indicate a control device of a vehicle which is suitable for carrying out the method.

These objects are achieved by a method according to the features of the claimed invention.

A method for reproducing a fault which occurs during the driving operation of a vehicle is proposed. Said method comprises the step of fixing the vehicle in position in order to prevent a relative movement relative to a reference surface on which the vehicle is located. The method comprises the further step of the reading of a speed profile, which is provided by an engine tester and simulates the driving situation in which the fault has occurred during the driving operation, by the engine tester into a control device of the vehicle. Finally, the method comprises the step of automated traveling along the speed profile by the control device which converts the speed profile into at least one control parameter of the engine, in particular the internal combustion engine, and/or of the transmission over time, in the vehicle when the vehicle is loaded by activation of its brake.

In other words, a driving profile which reproduces the fault and in which the load and/or rotational speed of the engine, in particular the internal combustion engine, are varied up to when the fault situation is executed. The execution of the load profile occurs here when the vehicle is fixed in position, wherein the fixing in position is intended to prevent a relative movement of the vehicle with respect to the reference surface, in order to prevent the vehicle from injuring or damaging nearby persons or objects in the workshop or the test location. The proposed method makes it possible for a fault occurring during the load operation to be located in a workshop, in that a service technician can simulate the fault with a high level of probability and produce a fault diagnosis without having to make a test run.

The execution of the load profile is made possible by virtue of the fact that a speed profile which is stored in an engine tester is converted into a corresponding load profile. The conversion of the speed profile into the load profile can be performed, for example, by an adaptive cruise controller or some other driving assistance system. Engine control devices are to a certain extent also already inherently designed to carry out this object. The speed profile which is firstly stored in the engine tester is read from it by the control device. For this purpose, the control device of the vehicle is connected to the engine tester e.g. via a cable or a wireless communication link in order to exchange data.

This makes it possible to determine the customer complaint occurring during a real driving operation in an artificial operation. As a result of this, faulty repairs can be reduced and increases in warranty costs prevented and repeated visits by the user of the vehicle avoided.

In a vehicle with a conventional internal combustion engine, the addition of load by the internal combustion engine occurs during the increase in load by the oil of its transmission or its converter or clutch. In the case of a hybrid vehicle, the increase in loading occurs either by the internal combustion engine or by a first electric machine (referred to as a motor generator) or by a combination of the internal combustion engine and the first electric machine. The take up of the load occurs in the hybrid vehicle by way of the oil of its transmission or a second electric machine or a combination of the gear oil and second electric machine. If an electric machine is used to take up the load, it is possible, depending on the topology that in the stationary state the respective corresponding battery of the vehicle can be charged by a generator. If a certain load is taken up by the second electric machine, the automatic gear oil can be relieved of thermal loading.

The fixing of the vehicle in position in order to prevent a relative movement can be done in various ways. In particular, the fixing of the vehicle in position can comprise automated, constant activation of the brakes of the vehicle brought about by the control device. Alternatively or additionally, manual activation can be carried out by a service technician while the method according to the invention is being carried out. The automated constant activation of the brakes comprises, in particular, maximum application of a braking force in order to ensure that the vehicle is securely fixed under all circumstances, that is to say for any load which is requested. The automated activation of the brakes can be implemented, in particular, by the control device which performs the automated execution of the speed profile. For this purpose, in particular the control device which simulates the function of a driver assistance system can be used, such as for example a braking assistant or a driver assistance system for autonomous or partially autonomous longitudinal movement of a vehicle.

Alternatively or additionally, the fixing of the vehicle in position can comprise arranging the vehicle in such a way that its wheels are freely rotatable. For this purpose, the vehicle can be arranged, for example, on a lifting platform. In the event of the braking torque or the braking force which is applied by the brakes being insufficiently large to prevent rotation of the wheels when the loading profile is executed, locomotion of the vehicle can be reliably prevented in a workshop environment.

A further alternative or additional refinement consists in additionally fixing the vehicle in position mechanically. For this purpose, for example the vehicle can be clamped tight by its trailer hitch, its towing hook or the like. The mechanical fixing in position can be carried out with cables, rods and other suitable elements.

A further expedient refinement provides that a sensor senses a temperature signal which represents a transmission temperature and/or a clutch temperature and transfers the temperature signal to the engine control device for comparison with a specified threshold value temperature, wherein the traveling along the speed profile is aborted if the temperature signal is higher than the specified threshold value temperature. For this purpose, the sensor can sense, for example, the temperature of the oil of the transmission and/or of the clutch. This refinement is based on the consideration that as a result of the increase in loading heat is introduced into the transmission and/or the clutch, and brings about an increase in the heat of the oil surrounding these components. In order to avoid thermal overheating and resulting

damage to the components, the introduced energy is monitored in order, if appropriate, to be able to abort the execution of the method before a damage situation occurs.

A further expedient refinement provides that the at least one control parameter of the engine comprises an engine speed and/or load which is requested by the engine, that is to say a setpoint torque. Alternatively or additionally, the at least one control parameter of the transmission can comprise a drive position. In particular, the control parameters are parameters which are respectively specified for a specified time, in order to be able to simulate a time-dependent speed profile.

A further expedient refinement provides that a driver assistance system control device monitors whether a relative movement is detected during the test, wherein when a relative movement is detected by the driver assistance system control device a control signal for activating a brake, in particular a parking brake, is output. In this way, the fixing of the vehicle in position can be additionally brought about in order to prevent a relative movement.

It is also expedient if the step of traveling along the speed profile is carried out by the driver assistance system control device as the control device. Alternatively or additionally, the step of traveling along the speed profile is carried out by an engine control device as corresponding control device. Which of the control devices implements the method according to the invention can be made dependent, in particular, in which control device corresponding program parts are present in, in order to convert a speed profile read in by the engine tester into a load profile.

In addition, a computer program product is proposed which can be loaded directly into the internal memory of a digital computer and comprises software code sections with which the steps of the method described herein are executed when the product runs on the computer. The computer program product can be present in the form of a data carrier, for example a CD-ROM, a DVD, or a USB memory stick. It can also be present in the form of a signal which can be loaded via a wireless or line-bound communication network.

In addition, a control device is proposed which is configured to execute the method described herein. The control device has the same advantages as have been described above in conjunction with the method according to the invention.

Further advantages, features and refinements of the invention become clear on the basis of the exemplary embodiment described below in the drawings.

### BRIEF DESCRIPTION OF THE DRAWINGS

FIG. 1 shows a schematic illustration of a program flow diagram of an embodiment of a method according to the invention.

FIG. 2 shows a schematic illustration of the components of a vehicle and of an engine tester which are involved in the execution of an embodiment of the method according to the invention.

### DETAILED DESCRIPTION OF THE DRAWINGS

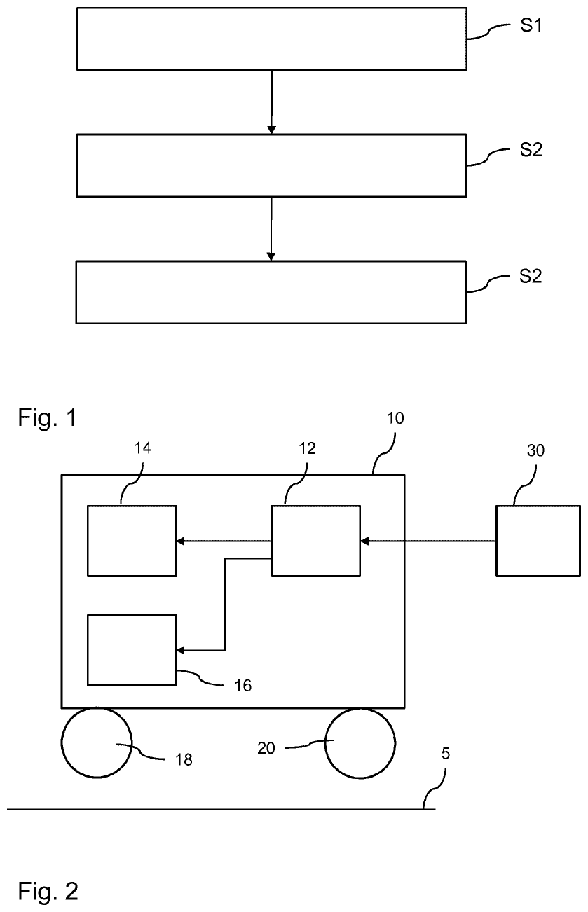

The reproduction of a fault that occurs during the driving operation of a vehicle 10 is made possible using the sequence shown in FIG. 1 for an embodiment of the method according to the invention. The vehicle 10, which is illustrated schematically in FIG. 2, comprises an internal combustion engine and/or an electric motor as a drive source/drive sources. The vehicle 10 comprises a control device 12, the engine 14, which has already been mentioned as a drive source, and a brake 16 which acts on wheels 18, 20. The control device 12 is configured to be connected to a vehicle-external engine tester 30, in order to exchange this data therewith.

In order to carry out the method according to an embodiment of the invention, according to step 51 the vehicle 10 is fixed in position in a test environment, for example a workshop of the vehicle manufacturer. The fixing of the vehicle 10 in position can be carried out using the brake 16 which acts on the wheels 18, 20. The brake 16 is firstly activated to a maximum extent, in particular in an automated fashion. As a result, within the scope of the method described above the residual braking effect of the brake 16 can be sensed. This makes it possible to determine whether the brake 16 can retain the maximum requested torque. The activation of the brake 16 is brought about, in particular, by the control device 12, and preferably in such a way that the brakes exert a maximum braking force on the wheels or the braking means (brake disk or drum) connected to the wheels 18, 20. In addition, the vehicle can be optionally fixed in position externally. For example, the vehicle can be tied down by cables and/or rods at its trailer hitch (not shown) and/or at a towing hook (not shown) and/or the wheels 16, 18. The vehicle can also be fixed in position in such a way that the vehicle 10 is arranged with respect to a reference surface 5 in such a way that its wheels are freely rotatable. For this purpose, the vehicle 10 can be arranged e.g. on a lifting platform.

As becomes clear from the following description, the method is carried out with the brakes 16 closed, that is to say activated, so that the wheels 18, 20 do not rotate. The arrangement of the vehicle 10 such that the wheels cannot freely rotate occurs for safety reasons in order to prevent undesired relative movement with respect to the reference surface 5, which would possibly be dangerous for people located in the surroundings. In addition, this is intended to avoid damage to the vehicle 10 and/or the elements in the surroundings.

According to step S2, a speed profile which is provided by the engine tester 30 is read in. The speed profile, which can be generated manually and/or automatically, simulates as well as possible, in particular, the driving situation in which a fault which was reported by the user of the vehicle has occurred during the driving operation. The reading in is carried out by the engine tester 30 into the control device 12 of the vehicle.

Since a large number of phenomena occur only at specific engine temperatures, such as e.g. an internal combustion engine which is running unsteadily at a cold start or a lack of engine power when the engine is warm or juddering when warming up, it is expedient to specify the input which is provided by the engine tester 30 not only as a speed profile but optionally also as a speed engine temperature profile. The “setpoint temperature” of such a profile can then be applied for the reproduction with the customary possibilities of the vehicle-internal cooling circuits.

The sequence of the steps 51 and S2 can also be carried out herein in the reverse order, that is to say the step S2 can be carried out before the execution of the step 51.

In a subsequent step S3, an automated execution of the speed profile occurs under the control of the control device 12. For this purpose, the control device 12 converts the speed profile into one or more control parameters of the engine 14 and/or of a transmission (not illustrated in more detail) over time, in order to generate a load profile. The load profile comprises a successive increase in load (i.e. torque which is applied to the wheels 18, 20) and engine speed until the fault situation reported by the user is reached or exceeded. The conversion of the speed profile into the control parameter or parameters of the engine and/or of the transmission is carried out here in an automated fashion by the control device 12, which inherently has such conversion functionalities.

Such a control device 12 can be, for example, an engine control device or else driver assistance control device, such as for example the control device of an automatic parking function (known as a parking pilot or remote control parking, RCP) or an adaptive cruise control system which generate corresponding load parameters and rotational speed parameters on the basis of a speed specification. A driver assistance control device which implements an automatic parking function can, furthermore, also be used to activate the brake 16, in order to prevent rotation of the wheels 18, 20.

Since the application of a load to the engine 14 and the transfer of said load to the wheels 18, 20 via the transmission (not illustrated) results in slip in the clutch (not illustrated), said clutch warms up. The thermal loading can be carried away only to an insufficient degree over a relatively long time since the stationary vehicle does not have a flow of air around it. In order to avoid thermal damage, a sensor (not illustrated) senses a temperature signal which represents the transmission temperature and/or clutch temperature and transfers it to the control device 12 for comparison with a specified threshold value temperature. If it is detected during the execution of the speed profile that the determined temperature signal is higher than the specified threshold value temperature, the execution of the speed profile is automatically aborted. The thermally loaded component can then, if expedient, be changed, for example, into a “cooling cycle” in order to reduce the thermal loading during operation. As described, the sensor or the temperature calculation model can sense, in particular, the temperature of the oil of the transmission and/or of the clutch. During the conversion of the speed profile into the load profile, the control of torque, rotational speed and time can be implemented in such a way that a maximum tolerable input of energy into the transmission and/or the clutch is not exceeded.

The load which occurs in practice during the execution of the speed profile is simulated by the brake 16, wherein the brake 16 is, as described above, constant and, in particular, depressed to a maximum degree.

The method according to an embodiment of the invention can be implemented, in particular, in such vehicles which have an automatic transmission, since in said vehicles the corresponding gear speeds of the transmission can also be changed automatically by the control device in order to simulate the speed profile. In this context, transmission and clutch protection functions which are present for protecting against thermal overheating of the torque converter can be used so that in the case of an increased input of heat a prompt decrease in the loading can be implemented.

The method according to an embodiment of the invention permits a customer complaint which occurs during the driving operation of the customer to be simulated. This is made possible by converting a relevant speed profile into a load profile. As a result, repair measures can be validated under load. Workshops can dispense with the execution of a test run. Faulty repairs or repairs based on faulty information can be avoided.

### LIST OF REFERENCE NUMBERS

5 Reference surface
10 Vehicle
12 Control device
14 Engine
16 Brake
18, 20 Wheels
30 Engine tester

1.-13. (canceled)

14. A method for reproducing a fault that occurs during a driving operation of a vehicle, the method comprising:
fixing the vehicle in position in order to prevent a movement relative to a reference surface on which the vehicle is located;
reading a speed profile, which simulates a driving situation in which the fault has occurred during the driving operation, by an engine tester into a control device of the vehicle; and
providing automated traveling along the speed profile by the control device, which converts the speed profile into at least one control parameter of at least one of an engine or a transmission over time, in the vehicle when the vehicle is loaded by activation of a brake.

15. The method according to claim 14, wherein the fixing the vehicle in position comprises automated, and constant activation of the brake of the vehicle brought about by the control device.

16. The method according to claim 15, wherein the fixing the vehicle in position further comprises a maximum activation of the brake of the vehicle brought about by the control device.

17. The method according to claim 14, wherein the fixing the vehicle in position comprises arranging the vehicle such that wheels of the vehicle are freely rotatable.

18. The method according to claim 14, wherein the fixing the vehicle in position comprises mechanical fixing in position.

19. The method according to claim 14, wherein:
a sensor senses a temperature signal which represents at least one of a transmission temperature or a clutch temperature, and transfers the temperature signal to the control device for comparison with a specified threshold value temperature, and
the traveling along the speed profile is aborted if the temperature signal is higher than the specified threshold value temperature.

20. The method according to claim 14, wherein
the at least one control parameter of the engine comprises at least one of an engine speed or a load requested by the engine.

21. The method according to claim 14, wherein the at least one control parameter of the transmission comprises a drive position.

22. The method according to claim 14, wherein:
a driver assistance system control device monitors whether a relative movement is detected during a test, and
when the relative movement is detected by the driver assistance system control device, a control signal for activating a parking brake is output.

23. The method according to claim 14, wherein a speed engine temperature profile is processed as the speed profile.

24. The method according to claim 14, wherein providing the automated traveling along the speed profile is carried out by a driver assistance system control device as the control device.

25. The method according to claim 14, wherein providing the automated traveling along the speed profile is carried out by an engine control device as the control device.

26. A computer program product comprising a non-transitory computer readable medium having stored thereon program code which, when executed on a processor, a microcontroller, or a programmable hardware component, carries out a method for reproducing a fault that occurs during a driving operation of a vehicle, the method comprising:
fixing the vehicle in position in order to prevent a movement relative to a reference surface on which the vehicle is located;
reading a speed profile, which simulates a driving situation in which the fault has occurred during the driving operation, by an engine tester into a control device of the vehicle; and
providing automated traveling along the speed profile by the control device, which converts the speed profile into at least one control parameter of at least one of an engine or a transmission over time, in the vehicle when the vehicle is loaded by activation of a brake.

27. A control device of a vehicle which is configured to execute a method for reproducing a fault that occurs during a driving operation of the vehicle, the method comprising:
fixing the vehicle in position in order to prevent a movement relative to a reference surface on which the vehicle is located;
reading a speed profile, which simulates a driving situation in which the fault has occurred during the driving operation, by an engine tester into a control device of the vehicle; and
providing automated traveling along the speed profile by the control device, which converts the speed profile into at least one control parameter of at least one of an engine or a transmission over time, in the vehicle when the vehicle is loaded by activation of a brake.
